(19) United States
(12) Patent Application Publication
(10) Pub. No.: US 2007/0219884 A1
(43) Pub. Date: Sep. 20, 2007

(54) METHOD FOR THE MONETARY VALUATION OF TRADEMARKS

(75) Inventor: Robert Tafelmeier, Landshut (DE)

Correspondence Address: PEARNE & GORDON LLP, 1801 EAST 9TH STREET, SUITE 1200, CLEVELAND, OH, 44114-3108, US

(73) Assignee: IP-VALUATION GmbH, Munchen (DE)

(21) Appl. No.: 11/684,892

(22) Filed: Mar. 12, 2007

(30) Foreign Application Priority Data
Mar. 14, 2006 (DE) 10 2006 011 691.7

(51) Int. Cl. G06Q 40/00

(52) U.S. Cl. 705/35

(57) ABSTRACT

It is becoming increasingly important to many business enterprises to put a monetary value on individual trademarks or on an entire trademark portfolio. To simplify trademark valuation without this resulting in any loss of quality, and in particular to provide a method for valuation of trademarks, which method can be carried out quickly and economically in-house by the business enterprise concerned, without there being a need to release company-internal data, according to the invention a novel valuation method is provided, in which method the value of a trademark is determined by means of a computer system (10) based on valuation-relevant data, with this value being issued to a user (12) of the computer system, wherein a part (20) of the valuation-relevant data (18, 20) must be input into the computer system by the user, whereas another part (18) of the valuation-relevant data (18, 20) has previously been entered and is stored in the computer system.

### BACKGROUND TO THE INVENTION

1. Field of the Invention

The invention relates to a method for the monetary valuation of trademarks.

Over the past few years the share of intangible assets in the overall value of many business enterprises has steadily increased. In many sectors, the value of these intangible assets already clearly surpasses the value of materially tangible assets (e.g. buildings, plant, and other operating resources).

Against this background it is becoming increasingly important to many business enterprises to put a monetary value on individual trademarks or on an entire trademark portfolio. There are many reasons for the need for such a valuation, including, for example, the purchase or sale of trademarks, M&A transactions, company-internal reporting, securing credit, determining the extent of payments relating to trademark licenses, balance sheet entries relating to trademarks, etc.

2. Description of Prior Art

While there are a few companies that provide trademark valuations for business enterprises, the known methods are, however, associated with a relatively low degree of objectivity in the valuation, as well as with a number of other disadvantages. For example, the business enterprise concerned first has to disclose company-internal, and thus usually confidential, data to the provider of trademark valuations. Apart from any confidentiality-related problems associated with this, it involves also considerable expenditure for the enterprise. Lastly, known valuation methods involve very considerable expenditure in time (typically several months) in order to compile further valuation-relevant data, for example concerning market characteristics for a particular industry sector. This data acquisition, which has to be carried out individually for each trademark valuation, usually requires the additional participation and coordination of experts in trademark law, patent attorneys, management consultants etc. In particular for this reason it is not unusual for a conventional valuation of a trademark to involve expenditure amounting to 30,000 to 200,000 EUR.

### BRIEF DESCRIPTION OF THE INVENTION

It is thus an object of the present invention to simplify trademark valuation without this resulting in any loss of quality, and in particular to provide a method for valuation of trademarks, which method can be carried out quickly and economically in-house by the business enterprise concerned, without there being a need to release company-internal data.

This object is met by a method according to claim 1. The dependent claims relate to advantageous improvements of the invention, which improvements can also particularly advantageously be combined with each other.

First of all, it is significant in the context of the invention that in the method for the monetary valuation of trademarks the value of a trademark is determined by means of a computer system based on valuation-relevant data, with this value being issued to a user of the computer system. Furthermore, it is significant that a part of the valuation-relevant data must be input into the computer system by the user, whereas another part of the valuation-relevant data has previously been entered and is stored in the computer system.

As a result this creates a valuation method that advantageously is to be carried out by the business enterprise itself, which valuation system can be carried out quickly and economically without the need to release company-internal data. Such confidential data, e.g. turnover figures of the business, can be entered by the user him/herself so that they remain confidential.

Advantageously the new valuation method not only solves the problems associated with confidentiality relating to the business enterprise concerned, but also, because part of the valuation-relevant data remains within the sphere of the user, and because such data is used in a computer-assisted calculation method, any subjectivity is precluded so that a high degree of objectivity in the valuation is achieved. The method provides independent monetary valuation of trademarks while involving very little expenditure for the user during the valuation process. The method can be carried out in an easy way, 24 hours a day, 365 days a year.

Preferably the part of the valuation-relevant data that has previously been entered and is stored in the computer system comprises country-specific data and/or industry-sector-specific data. This data for a multitude of countries and industry sectors can then be used in a targeted manner in the valuation algorithm applied, depending on the data (user data) entered by the user. Preferably this data, which has been provided previously, relates to at least 100 countries or at least 100 industry sectors.

In a preferred embodiment the part of the valuation-relevant data which has previously been entered and is stored can be updated so that in particular country-specific and/or industry-sector-specific market characteristics, or the valuation algorithm applied, can always be optimally matched to the conditions at a given time. An improvement of the invention provides for the part of the valuation-relevant data that has previously been entered and is stored to be regularly updated, e.g. at least once a year.

One embodiment provides for the computer system to comprise a stand-alone computer, in particular a conventional computer (PC etc.). In this case it can be made possible, in an easy way, for the user to carry out the valuation method in that an autonomous software program that is executable on the user's computer is transferred. As an alternative, the computer system can, for example, comprise an internet server which the user accesses by way of the internet in order to carry out the trademark valuation. In this variant, the confidentiality of the data entered by the user can be ensured by way of methods that are known per se, such as password protection and/or encryption.

Advantageously, as a result of the new calculation method it is possible to achieve a high degree of objectivity and standardisation. Moreover, as a result of the computer-assisted valuation it is also possible to present each valuation step so that it can be clearly understood by the user, in particular if for this purpose a display-supported man-machine dialogue with input masks etc. is provided. In this arrangement it is particularly advantageous if the user, prior to completion of valuation, is in a position to edit or correct the valuation-relevant data, for example in a menu structure and input mask structure that can be operated intuitively, in which structure the user can not only move “forward”, but can also go back to previous input steps and can make changes therein.

As far as the actual valuation algorithm is concerned, subjective elements and case-specific “expert opinions” can be avoided right from the very beginning. Furthermore, the valuation algorithm can advantageously take into account national and international accounting regulations. Moreover, recognised calculation methods can be implemented by way of the algorithm used. According to regulations of IAS/IFRS and US-GAAP, e.g. the income-oriented valuation algorithms are best suited to trademark valuation, wherein methods with discounted cash flows or revenues are favoured. The fair-value perspective is contained in the market-oriented trademark value; and as a result of the novel method of valuation said fair-value perspective can also be taken into account in a simple manner. Advantageously all the hitherto used evaluation approaches can be implemented, or taken into account in combination. This includes, for example, market-price-oriented methods (e.g. market prices on the active market, analogy methods etc.), income-oriented methods (e.g. license price method, surplus profit method, company-oriented methods etc.), cost-oriented methods (historical cost method, replacement cost method etc.) etc.

Preferably during valuation first a valuation type that is to be entered by the user is taken into account, which can, in particular, be the so-called “market-oriented trademark value” or the so-called “company-specific trademark value”. Depending on the selection by the user in relation to the calculation method, values of the industry-sector related trademark revenues or values of the company-specific trademark revenues can be taken into account as significant valuation-relevant data.

Preferably, when determining the two types of trademark value, the trademark revenues as well as so-called “protection values” of the trademark(s) are taken into account. The protection value of a trademark equals the sum of those expenses that would arise from authorities and attorneys in the context of applying for the current protection form (e.g. territorial scope of protection) in relation to the trademark. The part of the valuation-relevant data, which part has previously been entered and is stored in the computer system, contains data, broken down according to industry sectors and countries, relating to trademark revenues and protection values. If the user wishes to determine the market-oriented trademark value, the valuation algorithm can advantageously access this data provided by the computer system. This also applies to determining the company-specific trademark value, wherein according to a preferred embodiment of the invention there is then, however, an option for the user to substitute the data provided by the computer system with company-specific data.

In an embodiment that is very advantageous to the user, issuing the trademark value takes place as part of a trademark valuation report made available to the user. Such a report can e.g. be provided in the form of visual output, and/or in the form of a storable file. In this arrangement the report can reflect in a particularly clear form at least part, in particular a large part, or essentially all, of the data that formed the basis of the valuation, and can reflect the valuation result (trademark value).

The data entered into the computer system by the user can be subjected to an automatic plausibility check prior to finalising trademark valuation and in particular already during input. Such a check and if need be notes that are issued further simplify operation for the user. The part of the valuation-relevant data, which part can be entered by the user, can for example comprise a trademark type and/or a circumstance relating to trademark usage and/or a valuation date and/or a valuation currency and/or a valuation type and/or a territory of proprietary right and/or company turnover values.

The data entered by the user can be taken into account directly (as arithmetic values) in the valuation algorithm, e.g. as turnover values. As an alternative, or in addition, this data, for example relating to the trademark type or to circumstances relating to trademark usage, can also influence the selection and use of data previously entered and stored.

One embodiment provides for the number of trademark valuations to be carried out to at first be limited. As an alternative or in addition, the period of time in which a user can carry out trademark valuations can be limited, supported by a program. Said program can either be provided e.g. for stand-alone software, or for online access to a computer system that has been implemented as an internet server.

### BRIEF DESCRIPTION OF THE DRAWINGS

Below, an exemplary embodiment of the invention is described in more detail with reference to the enclosed drawings. The following are shown:

FIG. 1 a block diagram to illustrate the valuation of a trademark, which valuation is carried out by a user with the use of his/her own computer; and

FIG. 2 a basic sequence program of the valuation method.

### DESCRIPTION OF THE PREFERRED EMBODIMENT(S)

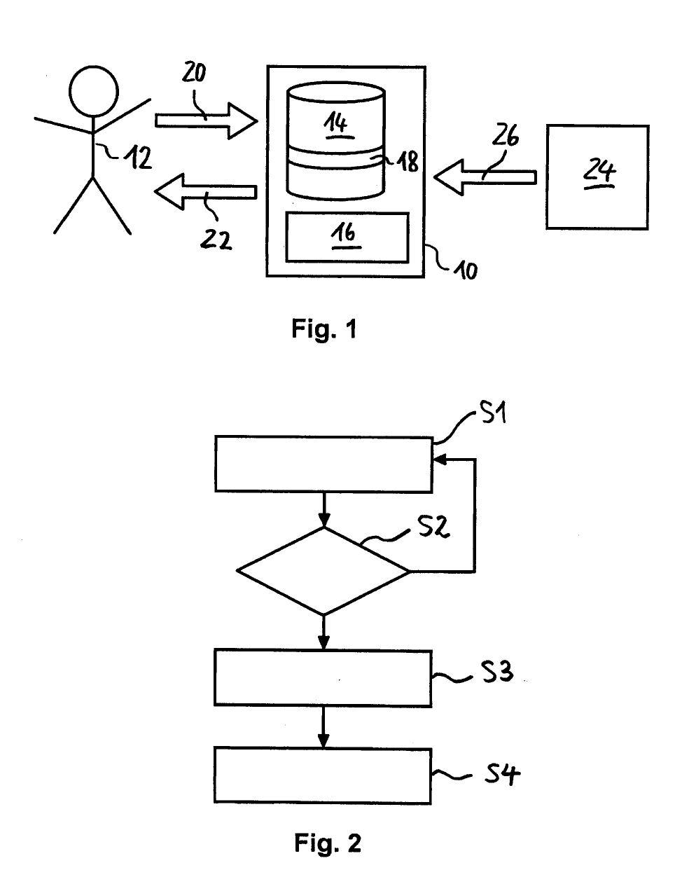

FIG. 1 shows a conventional computer 10 (PC) of a user 12.

In a manner that is known per se, the computer 10 comprises a storage device 14 (e.g. hard disk) for storing programs and data, a central data processing unit 16, as well as a man-machine interface (not shown), by way of which the user 12 communicates with the computer 10 (e.g. display screen device and keyboard device etc.).

The user 12 him/herself can quickly, objectively and economically assess the value of one or several trademarks of his business enterprise in the manner described below by means of the computer 10. To this effect software runs on the computer 10, which software provides a calculation algorithm suitable for this, and further provides a part 18 of the valuation-relevant data. Another part 20 of the valuation-relevant data is entered into the computer 10 by the user 12 by way of the man-machine interface.

In the method for the monetary valuation of the trademark(s), which method is implemented with the support of software, the value of a trademark is determined by means of the computer 10, based on the valuation-relevant data 18, 20, and, at the end of the valuation process, is issued to the user 12 by way of the man-machine interface as part of a comprehensive valuation report 22.

A decisive practical advantage of the method consists of data 20, in particular confidential operation-related data that has an influence on the trademark value, being entered by the user him/herself so that this data cannot end up with an outside third party, whereas another part 18 of the valuation-relevant data has previously been entered and is stored in the computer system, wherein such data relates, for example, to country-specific and industry-sector-specific details.

This latter part 18, which has previously been entered and is stored, is regularly updated by a provider 24 (compare arrow 26). The data 18 provided by the provider 24, including the details of the valuation algorithm used, is generated for a multitude of users such as user 12 by an extensive survey of market data, and is constantly updated so that the expenditure accruing for this to the user 12 only needs to be calculated on a pro-rata basis and is thus advantageously very small. In the example shown, updating 26 takes place by a regular dispatch (approximately quarterly) of a CD-ROM to the user 12. In an online variant of the method, in which method the user 12 has access to an internet server by way of a password-protected internet connection, the software running on the computer system and that part of the valuation-relevant data that has previously been entered and is stored on the computer can be updated directly.

In each case a simple and reliable method for the monetary valuation of trademarks, in particular of the trademarks of his/her own business enterprise, is made available to the user 12, wherein each type of trademark can be valued with the use of the software program. This does not require any disclosure of company-internal and in particular confidential data 20.

FIG. 2 diagrammatically shows the basic sequence of trademark valuation by the system shown in FIG. 1.

Processing commences with a step S1, in which the user 12 enters the data 20 into the computer system 10 by way of a software surface whose operation is intuitive, and which software surface comprises several input masks. This data 20 comprises in particular the type of trademark (word mark, logo, three-dimensional mark, sound mark etc.), circumstances relating to trademark usage (e.g. whether or not the trademark is being used), a valuation date (for which the trademark value is to be calculated), a valuation currency, an industry sector of the trademark user etc. Furthermore, in this step S1 the user 12 selects from an extensive country list those countries (in excess of 100 countries) in which the trademark is protected or in which trademark protection can still be obtained. Advantageously, in order to increase the reliability of the trademark valuation, in this step a multitude of data is polled, which data can easily be determined from the company data of the user 12, e.g. data relating to trademark use, wherein such turnover advantageously is also taken into account for several previous years, broken down according to countries or regions.

The valuation algorithm implemented by means of the computer 10 uses this input data 20 together with the data already contained in the software or in the data part 18 in order to determine from it the trademark value which is free of any subjective influences.

Although within the context of the valuation, a multitude of operational parameters that have been determined according to recognised principles, for example turnover growth rates, operating profits from trademark turnover, taxation rates, net operating profit after taxes (NOPAT), capital cost rates, trademark-specific contributions to income values, discount rates and discount factors etc. are taken into account, the user 12 is not burdened with these details of calculation. Calculation and further consideration of such parameters takes place in a software-supported manner on the basis of comparatively few parameters to be entered by the user. In this context it is worth mentioning that practically all the parameters that do not mandatorily depend on special characteristics of the trademark holder or of the trademark (e.g. all the parameters applying to trademarks destined for a particular industry sector or region) or which do not depend on the input data at all (e.g. capital-market-specific capital cost rates etc.) have previously been entered and are stored as the data part 18 in the computer 10 and are continually updated by the provider 24.

The data part 18 which has previously been entered and is stored in the computer or is contained in the valuation algorithm contains in particular industry-sector-specific and country-specific information that can be used to calculate trademark revenues and trademark protection values. In the exemplary embodiment described, the use of this “typical market data” is provided so as to be mandatory where the market-oriented trademark value is determined, whereas the use of this data is optional in cases where the company-specific trademark value is determined.

When the user 12 has entered his/her individual part 20 of the valuation-relevant data, processing progresses to a step S2 in which the user has an opportunity to alter previously entered data (return to step S1), or to end the data entry, as a result of which processing advances to a step S3.

In step S3 a valuation counter that defines the number of trademark valuations still to be carried out is decreased by 1, and in a step S4 finally a clearly presented trademark valuation report is shown for the user 12 and is made available as an electronic file. This report is prepared only if the originally specified number of market valuations to be carried out has not yet been exhausted by the user 12.

With the described method, monetary valuation of trademarks of all kinds are possible. In principle the user 12 has the opportunity to calculate two types of a trademark value, which differ on the basis of the input data used (market-oriented trademark value or enterprise-specific trademark value).

Valuation-relevant data can be entered in a simple manner into the provided input fields. By means of the indicated calculation steps and in conjunction with the data already provided within the software, the trademark value is calculated quickly and economically. The data provided by the provider is regularly updated.

If the number of the trademark valuations to be carried out at the maximum and/or if the time period available for such valuations is limited, as is the case in the implementation example described above, then help texts output by the software program point out the specified limit values in the individual trademark valuation calculation. Furthermore, pointers are issued as to how the user can order from the provider a further number of trademark valuations or an extension of the period of use.

Advantageously the user does not need to have any in-depth business and management knowledge to carry out the trademark valuation. Calculation requires comparatively little input data by the user but is nonetheless of outstanding quality when compared to data associated with hitherto used valuation methods, which are significantly more expensive.

1. A method for the monetary valuation of trademarks, in which method the value of a trademark is determined by means of a computer system (10) based on valuation-relevant data, with this value being issued to a user (12) of the computer system, wherein a part (20) of the valuation-relevant data (18, 20) must be input into the computer system by the user, whereas another part (18) of the valuation-relevant data (18, 20) has previously been entered and is stored in the computer system.

2. The method according to claim 1, wherein the part (18) of the valuation-relevant data (18, 20), which part (18) has previously been entered and is stored, comprises country-specific data and/or industry-sector-specific data.

3. The method according to claim 1, wherein the part (18) of the valuation-relevant data (18, 20), which part (18) has previously been entered and is stored, can be updated.

4. The method according to claim 1, wherein the part (18) of the valuation-relevant data (18, 20), which part (18) has previously been entered and is stored, is regularly updated.

5. The method according to claim 1, wherein the computer system (10) is a stand-alone computer.

6. The method according to claim 1, wherein the computer system (10) is an internet server which the user (12) accesses by way of the internet in order to carry out the trademark valuation.

7. The method according to claim 1, wherein issuing the trademark value takes place as part of a trademark valuation report (22) made available to the user.

8. The method according to claim 1, wherein the data entered into the computer system (10) by the user (12) is subjected to an automatic plausibility check.

9. The method according to claim 1, wherein the part (20) of the valuation-relevant data (18, 20), which part (20) is to be entered by the user (12), comprises a trademark type and/or a circumstance relating to trademark usage, and/or a valuation date and/or a valuation currency and/or a valuation type and/or a territory of proprietary right and/or company turnover values.

10. The method according to claim 1, wherein the number of the trademark valuations to be carried out is limited.

11. A computer system (10) designed to implement a method according to claim 1.

12. A computer program product for implementing a method according to claim 1 on a conventional computer (10).
